(19) United States
(12) Patent Application Publication
(10) Pub. No.: US 2025/0370702 A1
(43) Pub. Date: Dec. 4, 2025

(54) VOLUME ADJUSTMENT METHOD, DEVICE AND STORAGE MEDIUM

(71) Applicant: Beijing Zitiao Network Technology Co., Ltd., Beijing (CN)

(72) Inventors: Yi REN, Beijing (CN); Zhengliang HUANG, Beijing (CN); Xuexin YANG, Beijing (CN); Min WANG, Beijing (CN); Kaiqi WANG, Beijing (CN); Xuri YU, Beijing (CN)

(21) Appl. No.: 19/198,358

(22) Filed: May 5, 2025

(30) Foreign Application Priority Data
May 30, 2024 (CN) 202410693497.3

(51) Int. Cl. G06F 3/16; G06F 1/3212; H04R 1/10; H04R 29/00

(52) U.S. Cl. CPC G06F 3/165; G06F 1/3212; G06F 3/167; H04R 1/1025; H04R 29/001

(57) ABSTRACT

A volume adjustment method, a device and a storage medium are provided. The method includes: determining a reference volume corresponding to a target audio to be played; inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information; determining a target volume corresponding to the target audio according to the target volume adjustment information and the reference volume; and performing volume adjustment on the target audio based on the target volume, to enable an adjusted target audio to be played at the target volume.

### CROSS-REFERENCE TO RELATED APPLICATION

The present application claims priority of the Chinese Patent Application No. 202410693497.3, filed on May 30, 2024, the disclosure of which is incorporated herein by reference in its entirety as part of the present application.

### TECHNICAL FIELD

Embodiments of the present disclosure relate to the computer technology, in particular to a volume adjustment method and apparatus, a device, and a storage medium.

### BACKGROUND

With the rapid development of computer techniques, play devices may play a great variety of audios. When an audio is played, due to the preset and fixed volume of the audio itself, when the volume of the audio is not applicable to the user's play requirement, the user needs to adjust the volume adjustment bar of the play device manually to increase or decrease the play volume of the audio until the play volume satisfies the user's requirement. So the method that requires the user to adjust the play volume manually is cumbersome, and reduces the user experience.

### SUMMARY

The present disclosure provides a volume adjustment method and apparatus, a device and a storage medium, so as to adjust the volume of an audio dynamically, adjust the audio volume to a more suitable volume automatically, eliminate the operation of adjusting the play volume manually by the user and improve the user experience.

The embodiments of the present disclosure provide a volume adjustment method. The method includes: determining a reference volume corresponding to a target audio to be played; inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information; determining a target volume corresponding to the target audio according to the target volume adjustment information and the reference volume; and performing volume adjustment on the target audio based on the target volume, to enable an adjusted target audio to be played at the target volume.

The embodiments of the present disclosure further provide a volume adjustment apparatus, which includes a reference volume determination module, a volume adjustment information prediction module, a target volume determination module and a target audio volume adjustment module.

The reference volume determination module is configured to determine a reference volume corresponding to a target audio to be played.

The volume adjustment information prediction module is configured to input target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information.

The target volume determination module is configured to determine a target volume corresponding to the target audio according to the target volume adjustment information and the reference volume.

The target audio volume adjustment module is configured to perform volume adjustment on the target audio based on the target volume, to enable an adjusted target audio to be played at the target volume.

The embodiments of the present disclosure further provide an electronic device. The electronic device includes one or more processors and a memory. The memory is configured to store one or more programs. When the one or more programs are executed by the one or more processors, the one or more processors are caused to implement any volume adjustment method as described in the embodiments of the present disclosure.

The embodiments of the present disclosure further provide a storage medium including computer-executable instructions. When the computer-executable instructions are executed by a computer processor, the computer-executable instructions are used to perform any volume adjustment method as described in the embodiments of the present disclosure.

In embodiments of the present disclosure, a reference volume corresponding to the target audio to be played is determined; the target audio characteristic information corresponding to the target audio, the target user group characteristic information provided by the target user group, the current scenario characteristic information and the reference volume are input to an adjustment information prediction model that is pre-trained, to predict volume adjustment information and obtain target volume adjustment information; and according to the target volume adjustment information and the reference volume, a target volume that is more suitable for the target audio can be determined accurately, and the volume of the target audio is adjusted based on the target volume, so that the adjusted target audio can be played at a more suitable target volume automatically, thereby implementing dynamic adjustment of audio volume, eliminating the operation of adjusting the play volume manually by the user and thus improving the user experience.

### BRIEF DESCRIPTION OF DRAWINGS

In conjunction with the drawings and with reference to the following specific embodiments, the above and other features, advantages and aspects of each embodiment of the present disclosure will become more apparent. Throughout the drawings, identical or similar drawing marks indicate the same or similar elements. It should be understood that the drawings are schematic in nature and that the originals and elements are not necessarily drawn to scale.

FIG. 1 is a schematic flowchart of a volume adjustment method in an embodiment of the present disclosure;

FIG. 2 is a schematic flowchart of another volume adjustment method in an embodiment of the present disclosure;

FIG. 3 is a schematic flowchart of another volume adjustment method in an embodiment of the present disclosure;

FIG. 4 is a schematic structural diagram of a volume adjustment apparatus in an embodiment of the present disclosure; and

FIG. 5 is a schematic structural diagram of an electronic device in an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that the modifications of “one” and “a plurality of” mentioned in the present disclosure are schematic rather than restrictive, and those skilled in the art should understand that unless otherwise explicitly stated in the context, it should be understood as “one or a plurality of”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

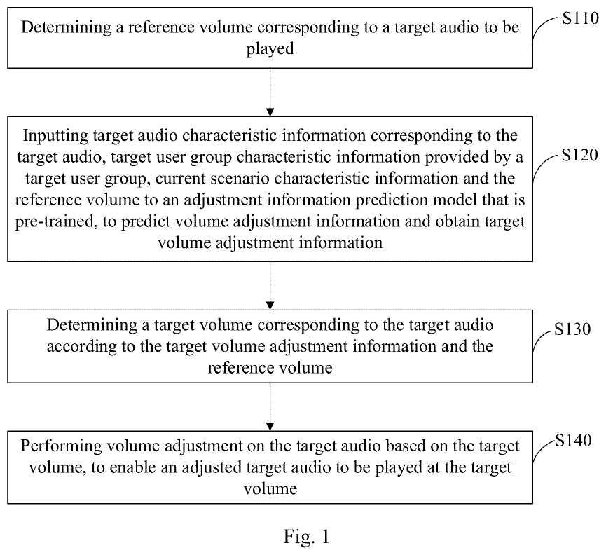

FIG. 1 is a schematic flowchart of a volume adjustment method in an embodiment of the present disclosure. The embodiment of the present disclosure is applicable to automatic adjustment of the volume of an audio itself and the method can be performed by a volume adjustment apparatus. The apparatus may be implemented in software and/or hardware and optionally by an electronic device. The electronic device may be a mobile terminal, a PC terminal, a server or the like.

As shown in FIG. 1, the volume adjustment method specifically includes the following steps.

S110: determining a reference volume corresponding to a target audio to be played.

Here, the target audio may be an audio that is waiting to be played currently. For example, when an audio is being played now, the next audio following the current audio may be taken as the target audio to be played. A target audio may refer to an audio that exists independently, for example, a music file or the like. A target audio may also be an audio added in a video. For example, a target audio refers to an audio in a target video to be played, so that the play volume of the video may be adjusted automatically by adjusting the volume of the audio in the video.

The reference volume corresponding to the target audio may be a volume baseline value that is referenced for adjusting the volume of the target audio. The reference volume corresponding to the target audio may be a volume suitable for the current play requirement, i.e., a volume of the target audio, at which there is a relatively high degree of interest. The degree of interest may be represented by the play duration of the target audio. For example, the longer the duration of playing the target audio at a certain volume is, the higher the degree of interest in the volume is. The reference volume is a suitable volume that is determined preliminarily for the target audio. The volume in the embodiments of the present disclosure may be represented by the loudness of an audio. The loudness is a measure of sound energy, and the greater the loudness of an audio is, the greater the auditory loudness for the user is. It is to be noted that the reference volume corresponding to a target audio may be different from the original volume set when the target audio was fabricated.

Specifically, the same reference volume may be set for each audio, for example, a preset volume may be determined as the reference volume corresponding to the target audio to be played. Alternatively, the reference volume corresponding to the target audio may also be determined dynamically in the two dimensions of audio and user group, so as to improve the accuracy of determination of the reference volume. For example, by a prediction manner of using a neural network, the reference volume corresponding to the target audio may be determined based on target audio characteristic information and target user group characteristic information. Or the reference volume corresponding to a target audio may be determined by using historical volume adjustment behavior information of the target user group for the target audio. Since different volumes may be preferred for different audio contents and different user groups may also prefer different volumes, for example, the middle-aged and elderly people prefer a high volume, a suitable reference volume may be determined preliminarily for the target audio considering the two characteristic dimensions of target audio and target user group. Since the target audio characteristic information and the target user group characteristic information are relatively stable characteristics, based on the two determination manners described above, a reference volume corresponding to each audio may be determined in a server in advance, and the reference volume corresponding to each audio may be sent to a client, so that in practical applications the client can rapidly determine the reference volume corresponding to a target audio from the reference volumes corresponding to each pre-delivered audio, thereby improving the efficiency of volume adjustment.

S120: inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information.

Here, the target audio characteristic information may refer to the original sound quality characteristic information of the target audio. For example, the target audio characteristic information may include, but not limited to, cutoff frequencies of the left and right channels, a phase check result and a statistic on waveform amplitudes. The target user group refers to a group, to which a target user needs to play the target audio currently, belongs. The target user group characteristic information refers to group characteristic information provided by the target user group. For example, the target user group characteristic information may include group portrait information such as the age bracket information corresponding to the target user group or the like. The current scenario characteristic information may refer to the characteristic information of the current play scenario. The current scenario characteristic information is real-time characteristics that change dynamically, and the target audio characteristic information and the target user group characteristic information are relatively stable characteristics. The adjustment information prediction model may be a neural network model that is used to predict adjustment behavior information for adjusting the input reference volume. The volume adjustment information predicted by the adjustment information prediction model may include a volume adjustment behavior and a volume adjustment magnitude. The volume adjustment behavior refers to a specific behavior needed by the target user group to adjust the reference volume of the target audio. For example, the target volume adjustment behavior may include a volume increasing behavior, a volume decreasing behavior or maintaining a volume unchanged. The volume adjustment magnitude refers to a magnitude, by which the reference volume of the target audio needs to be increased or decreased by the target user group.

For example, the target audio characteristic information may include, but not limited to, target audio general characteristic information and/or target audio feedback characteristic information. The target audio feedback characteristic information includes historical volume adjustment behavior information and/or a target historical volume of the target audio.

Here, the target audio general characteristic information may refer to general characteristic information of the original sound quality, such as cutoff frequencies of the left and right channels, a phase check result, a statistic on waveform amplitudes and the like. The target audio feedback characteristic information may refer to characteristic information fed back by the target user group with respect to the actual play volume of the target audio. For example, the target audio feedback characteristic information may include: historical volume adjustment behavior information of the target user group for the target audio and/or target historical volume. Here, the historical volume adjustment behavior information may include: frequency information of historical adjustment behaviors such as muting the target audio, adjusting the volume of the target audio or the like; and the play duration corresponding to a historical volume when the target audio is played by the target user group. The target historical volume is a historical volume that is determined to have the longest play duration based on the historical volume adjustment behavior information. By inputting the target audio feedback characteristic information to the adjustment information prediction model, the accuracy of predicting the current adjustment behavior can be further improved.

For example, the current scenario characteristic information may include, but not limited to, at least one selected from the group consisting of current play device characteristic information, current play environment characteristic information and current user behavior-pose information. Here, the current play device characteristic information includes at least one selected from the group consisting of current position information of a volume adjustment bar of a play device, a current usage state of earphones and a loudspeaker, a current battery level and a current heating temperature.

Here, the current position information of the volume adjustment bar of the play device is the information of the position, at which the volume adjustment bar is located currently in the play device, and the volume adjustment bar is used to adjust the play volume manually. The actual play volume of the target audio is determined based on the volume of the target audio itself and the current position information of the volume adjustment bar all together. The actual play volume refers to the auditory volume heard by the user actually. The current position information of the volume adjustment bar is used to represent the behavior information of the adjustment that is required for the volume of the audio itself by the play device. For example, the volume adjustment bar being located at the middle position represents that the volume of the audio itself needs no adjustment, i.e. the actual play volume is the volume of the audio itself. The volume adjustment bar being located at an upper position represents that the volume needs to be increased based on the volume of the audio itself, i.e. the actual play volume is higher than the volume of the audio itself. The volume adjustment bar being located at a lower position represents that the volume needs to be decreased based on the volume of the audio itself, i.e. the actual play volume is lower than the volume of the audio itself. The current position information of the volume adjustment bar varies dynamically with the manual adjustment operation by the user. In response to no manual adjustment operation being performed on the volume adjustment bar by the user, the current position information of the volume adjustment bar is still the position information of the volume adjustment bar obtained after the previous manual adjustment. The current usage state of earphones and a loudspeaker may represent whether the target audio is listened to through the earphones or the loudspeaker. For different listening manners, different volumes may be preferred. The current battery level and the current heating temperature may also affect the performance of the play device and the suitable play volume. The current play environment characteristic information may include the noise level in the current play environment and whether the current play environment is an indoor environment or an outdoor environment. The current user behavior-pose information may be used to represent the current behavior and pose of the user, such as walking, running or the like. Different user behavior-pose information may also affect the suitable play volume. For example, when the user prefers a relatively high volume when running, and then volume increase is needed.

Specifically, all the characteristic information capable of affecting the play volume of the target audio is input to the adjustment information prediction model, i.e., the target audio characteristic information, the target user group characteristic information, the current scenario characteristic information and the reference volume are input to the adjustment information prediction model. Based on stable characteristics such as the input target audio characteristic information and the target user group characteristic information and real-time characteristics such as the current scenario characteristic information, the adjustment information prediction model predicts accurately whether the target user group will adjust the input reference volume and the volume adjustment magnitude, and outputs the predicted target volume adjustment information, so as to obtain the target volume adjustment information. It is to be noted that the adjustment information prediction model is obtained by model training based on reference volumes corresponding to sample audios, sample audio characteristic information, sample user group characteristic information, sample scenario characteristic information and actual play volumes in advance. For example, based on the actual play volumes and the reference volumes of sample audios, the sample volume adjustment information corresponding to each sample audio is determined such as the sample volume adjustment behavior and the sample volume adjustment magnitude. The sample volume adjustment information is used as a sample label to perform model training under supervision, so as to obtain a prediction model capable of predicting volume adjustment information accurately.

For example, when the target audio is an audio in a target video to be played, the step S120 may include: inputting the target audio characteristic information corresponding to the target audio, target video characteristic information, the target user group characteristic information provided by the target user group, the current scenario characteristic information and the reference volume to the adjustment information prediction model that is pre-trained, to predict the volume adjustment information and obtain the target volume adjustment information.

Here, the target video characteristic information may refer to general characteristic information of the target video, such as duration of the target video, the number of times the target video has been viewed, video label information of the target video and the like. Specifically, when a target audio is an audio in the target video, the target video characteristic information may also need to be input to the adjustment information prediction model that is pre-trained, so as to further improve the accuracy of predicting volume adjustment information.

S130: determining a target volume corresponding to the target audio according to the target volume adjustment information and the reference volume.

Here, the target volume adjustment information may refer to the specific information needed to correct the reference information corresponding to the target audio. For example, the target volume adjustment information may include: a target volume adjustment behavior and a target volume adjustment magnitude. Here, the target volume adjustment behavior includes a volume increasing behavior, a volume decreasing behavior or maintaining a volume unchanged. The target volume may refer to a play volume of the target audio that is most suitable for the target user group currently. The target volume may also be considered as a play volume of the target audio, at which the target user group is most interested currently.

Specifically, based on the target volume adjustment information output from the adjustment information prediction model, the reference volume corresponding to the target audio is adjusted for correction, and a target volume more suitable for the target audio is obtained.

For example, the step S130 may include: in response to the target volume adjustment behavior being the volume increasing behavior, increasing the reference volume by a target volume adjustment magnitude to obtain a target volume corresponding to the target audio; in response to the target volume adjustment behavior being the volume decreasing behavior, decreasing the reference volume by a target volume adjustment magnitude to obtain a target volume corresponding to the target audio; and in response to the target volume adjustment behavior being the maintaining a volume unchanged, determining the reference volume as a target volume corresponding to the target audio.

Specifically, when the target volume adjustment behavior predicted by the adjustment information prediction model is the volume increasing behavior, a target volume adjustment magnitude is added to the reference volume, and the sum result obtained is determined as the final target volume. When the target volume adjustment behavior predicted by the adjustment information prediction model is the volume decreasing behavior, a target volume adjustment magnitude is subtracted from to the reference volume, and the difference obtained is determined as the final target volume. When the target volume adjustment behavior predicted by the adjustment information prediction model maintain the volume unchanged, the reference volume is directly determined as the final target volume. For example, a positive sign, a negative sign and zero may be used to denote the volume increasing behavior, the volume decreasing behavior and the maintaining a volume unchanged respectively. For example, in response to the reference volume corresponding to the target audio being 10 and the target volume adjustment information predicted by the adjustment information prediction model being +2, the final target volume is determined as 12.

S140: performing volume adjustment on the target audio based on the target volume, to enable an adjusted target audio to be played at the target volume.

Specifically, the volume of the target audio itself may be adjusted to the target volume through a volume equalization algorithm, which makes the adjusted volume of the target audio as the target volume, so that the play device may directly play the target audio at a more suitable target volume without adjusting the volume bar manually by the user to adjust the play volume to a more suitable target volume, eliminating the operation of adjusting the play volume manually by the user and improving the user experience. By adjusting the volume of the target audio to be played itself dynamically, the adjusted target audio can be directly played with a suitable matching target volume, thereby enabling intellectualized fine adjustment of audio volume.

In the technical solution of embodiments of the present disclosure, a reference volume corresponding to the target audio to be played is determined, and the target audio characteristic information corresponding to the target audio, the target user group characteristic information provided by the target user group, the current scenario characteristic information and the reference volume are input to the adjustment information prediction model that is pre-trained, to predict volume adjustment information and obtain target volume adjustment information; and according to the target volume adjustment information and the reference volume, a target volume that is more suitable for the target audio can be determined accurately, and the volume of the target audio is adjusted based on the target volume, so that the adjusted target audio can be played at a more suitable target volume automatically, thereby implementing dynamic adjustment of audio volume, eliminating the operation of adjusting the play volume manually by the user and thus improving the user experience.

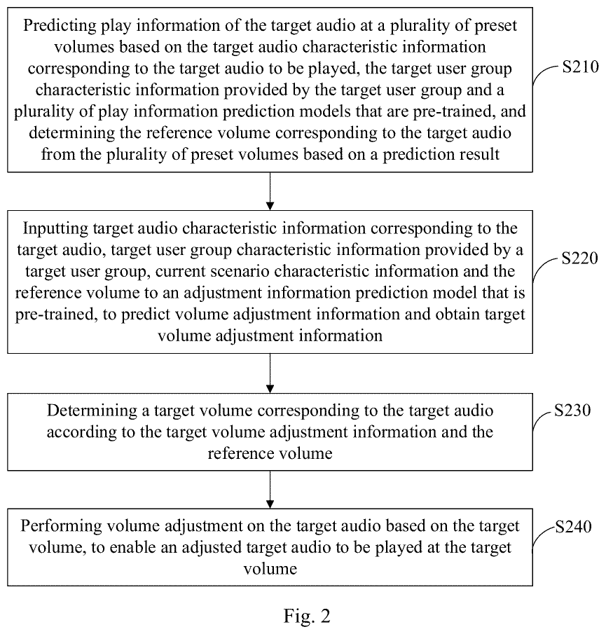

FIG. 2 is a schematic flowchart of another volume adjustment method in an embodiment of the present disclosure. In the embodiment of the present disclosure, based on the above-described embodiments, a process of determining a reference volume corresponding to a target audio using a plurality of play information prediction models is described in detail. The explanation of terminology the same as or corresponding to the embodiments of the present disclosure described above will not be repeated here.

As shown in FIG. 2, the volume adjustment method specifically includes the following steps.

S210: predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result.

Here, the play information prediction models may be neural network models that predict play information at particular volumes in the dimensions of user group and/or audio. Play information may be the information representing the degree of interest of the user group in the audio volume. For example, play information may refer to the play duration of an audio or the playback completion rate. At a certain volume, the longer the play duration of an audio is, or the higher the playback completion rate is, the higher the degree of interest of the user group in the volume is, i.e. the more the volume is suitable for the user group. The number of the play information prediction models is greater than one. Different play information prediction models are used to predict play information at different preset volumes. The play information prediction models are in one-to-one correspondence with the preset volumes.

Specifically, by using each play information prediction model that is pre-trained, the degree of interest of the target user group in each preset volume of the target audio may be predicted based on the target audio characteristic information and the target user group characteristic information. That is, the play information at each preset volume is predicted, and based on the play information corresponding to each preset volume, the preset volume of the target audio, at which the target user group is most interested, is determined from the plurality of preset volumes as the reference volume. Influences of the plurality of preset volumes on the user group and the audio may be predicted accurately by using the plurality of play information prediction models, so that a more accurate reference volume can be determined, thereby improving the accuracy of volume adjustment.

For example, the play information prediction models may be implemented in at least two ways. For example, one play information prediction model may be used to predict play information in the dimensions of user group and audio simultaneously, or two play information prediction models, i.e. a first prediction model and a second prediction model, may be used to predict play information in the dimension of audio and play information in the dimension of user group respectively.

In the first way of implementation, the step S210 may include: inputting the target audio characteristic information corresponding to the target audio to be played and the target user group characteristic information provided by the target user group to each play information prediction model that is pre-trained, to predict play information of the target audio that has a preset volume for the target user group; and, determining the reference volume corresponding to the target audio from a plurality of the preset volumes based on target play information output by each play information prediction model.

Specifically, when play information prediction models are used to predict play information in the dimensions of user group and audio simultaneously, the play information prediction models are in one-to-one correspondence with the preset volumes. By inputting the target audio characteristic information and the target user group characteristic information to each play information prediction model that is pre-trained, each play information prediction model may predict target play information of the target audio that has a corresponding preset volume for the target user group based on the input target audio characteristic information and target user group characteristic information, output the target play information, and based on the target play information corresponding to each preset volume, determine the preset volume best matching the target user group from all the preset volumes as a reference volume corresponding to the target audio. For example, when the target play information is the play duration corresponding to each preset volume, the preset volume that has the predicted longest play duration may be determined as the reference volume corresponding to the target audio, so that the reference volume suitable for the target user group and the target audio is obtained preliminarily based on such relatively stable characteristics as the target audio characteristic information and the target user group characteristic information.

It is to be noted that when play information prediction models are used to predict play information in the dimensions of user group and audio simultaneously, model training can be performed in advance based on the sample audio characteristic information corresponding to sample audios, the sample user group characteristic information and actual play volumes, to obtain the trained play information prediction models. An actual play volume may refer to the average play volume when a sample audio is actually listened to by a sample user group, and can be determined in the manner of experimental comparison. By training under supervision with actual play volumes corresponding to sample audios taken as labels, a prediction model that can predict play information accurately in the dimensions of user group and audio simultaneously may be obtained.

In another way of implementation, step S210 may include: inputting the target audio characteristic information corresponding to the target audio to be played to each first prediction model that is pre-trained, to predict play information of the target audio that has the first preset volume, and determining a first reference volume corresponding to the target audio from a plurality of the first preset volumes based on first play information output by each first prediction model; inputting the target user group characteristic information provided by the target user group to each second prediction model that is pre-trained, to predict play information of the target audio that has the second preset volume for the target user group, and determining a second reference volume corresponding to the target user group from a plurality of the second preset volumes based on second play information output by each second prediction model; and determining the reference volume corresponding to the target audio based on the first reference volume and the second reference volume.

Here, each play information prediction model includes: a first prediction model and a second prediction model. The first prediction model is a neural network model used to predict play information at a first preset volume in the dimension of audio. The second prediction model is a neural network model used to predict play information at a second preset volume in the dimension of user group. There are a plurality of first prediction models and a plurality of second prediction models. The first prediction models are in one-to-one correspondence with the first preset volumes, and the second prediction models are in one-to-one correspondence with the second preset volumes. The first preset volumes may be the same as, or different from the second preset volumes.

Specifically, when the play information in the dimension of audio and the play information in the dimension of user group are predicted by using the first prediction models and the second prediction models respectively, target audio characteristic information is input to each first prediction model that is pre-trained, and each first prediction model predicts and outputs the first play information of the target audio at each first preset volume based on the input target audio characteristic information. Based on the first play information at each first preset volume, a first reference volume more suitable for the target audio is determined from all the first preset volumes. For example, the first preset volume that has the longest predicted first play duration is determined as the first reference volume that is more suitable for the target audio. In a similar way, the target user group characteristic information is input to each second prediction model that is pre-trained, and each second prediction model predicts and outputs the second play information of the audio that has each second preset volume for the target group based on the input target audio characteristic information. Based on the second play information at each second preset volume, a second reference volume that is more suitable for the target user group is determined from all the second preset volumes. For example, the second preset volume that has the longest predicted second play duration is determined as the second reference volume that is more suitable for the target audio. The first reference volume and the second reference volume are averaged, and the obtained average reference volume is determined as the reference volume corresponding to the target audio. By using the first prediction models and the second prediction models, a reference volume that is suitable for the target user group and the target audio may also be obtained accurately.

It is to be noted that when the play information in the dimension of audio and the play information in the dimension of user group are predicted by using the first prediction models and the second prediction models respectively, model training may be performed in advance under supervision based on sample audio characteristic information and first actual play volumes corresponding to sample audios, to obtain the first preset models capable of accurate prediction in the dimension of audio. In a similar way, the model training may be performed in advance under supervision based on sample user group characteristic information and second actual play volumes corresponding to sample audios, to obtain the second preset models capable of accurate prediction in the dimension of user group. Here, the first actual play volumes may be determined through AB experiments for sample audios. The second actual play volumes may also be determined through AB experiments for user groups. In contrast to the actual play volumes in both the dimension of audio and the dimension of user group, the first actual play volumes in the dimension of audio and the second actual play volumes in the dimension of user group can be obtained more easily, so that the first prediction models and the second prediction models can be trained respectively, which decreases the difficulty of model training while ensuring prediction accuracy.

S220: inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information.

It is to be noted that in contrast to the play information prediction model, the adjustment information prediction model further uses real-time characteristics, such as the current scenario characteristic information, in addition to the target audio characteristic information and the target user group characteristic information, so that adjustment information that is needed currently to correct the reference volume dynamically can be determined accurately, and the reference volume can be adjusted for correction more accurately based on the adjustment information, thereby achieving a better matching target volume and improving intelligence and fineness of volume adjustment.

S230: determining a target volume corresponding to the target audio according to the target volume adjustment information and the reference volume.

240: performing volume adjustment on the target audio based on the target volume, to enable an adjusted target audio to be played at the target volume.

In the technical solution of embodiments of the present disclosure, based on the target audio characteristic information corresponding to the target audio to be played, the target user group characteristic information and a plurality of play information prediction models that are pre-trained, play information of the target audio is predicted at a plurality of preset volumes, and the reference volume corresponding to the target audio is determined from the plurality of preset volumes based on the prediction results, so that the influence of the plurality of preset volumes on the user group and the audio can be predicted accurately by using a plurality of play information prediction models, and thus a more accurate reference volume can be determined and the accuracy of volume adjustment can be improved.

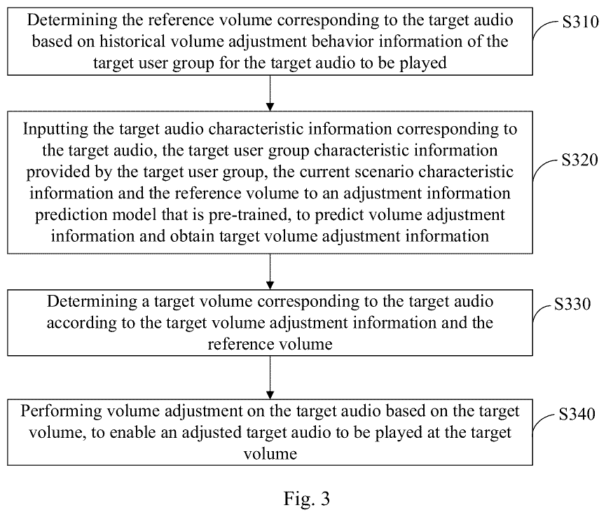

FIG. 3 is a schematic flowchart of another volume adjustment method in an embodiment of the present disclosure. In the embodiment of the present disclosure, based on the above-described embodiments, a process of determining a reference volume corresponding to a target audio by using historical volume adjustment behavior information is described in detail. The explanation of terminology the same as or corresponding to the embodiments of the present disclosure described above will not be repeated here.

As shown in FIG. 3, the volume adjustment method specifically includes the following steps.

S310: determining the reference volume corresponding to the target audio based on historical volume adjustment behavior information of the target user group for the target audio to be played.

Here, the historical volume adjustment behavior information may include: frequency information of historical adjustment behaviors by the target user group such as muting the target audio, adjusting the volume of the target audio or the like; and the play duration corresponding to a historical volume when the target audio is played by the target user group.

Specifically, by analyzing the historical volume adjustment behavior information of the target user group for the target audio, a reference volume that is more suitable for the target user group and the target audio may be inferred, and thus the accuracy of volume adjustment is improved.

For example, the step S310 may include: determining a target variation relationship between historical play volumes and average play durations of the target audio based on the historical volume adjustment behavior information of the target user group for the target audio; and determining a target historical volume for which the average play duration of the target audio is longest, and determining the target historical volume as the reference volume corresponding to the target audio.

Specifically, the average play durations corresponding to all the historical play volumes in the historical volume adjustment behavior information of the target user group for the target audio are fitted to a curve, to obtain the target variation relationship between historical play volumes and play durations. For example, the target variation relationship may be a variation curve present in a coordinate system that has historical play time as the horizontal axis and average play durations as the vertical axis. The historical play time corresponding to the highest point can be obtained from the variation curve corresponding to the target variation relationship and used as the target historical volume. The target historical volume is used as the reference volume that better matches the target audio and the target user group.

It is to be noted that in response to the reference volume being determined as the target historical volume that has the longest play duration based on the historical volume adjustment behavior information, it is no longer necessary to input the target historical volume to the adjustment information prediction model to predict adjustment information.

S320: inputting the target audio characteristic information corresponding to the target audio, the target user group characteristic information provided by the target user group, the current scenario characteristic information and the reference volume to an adjustment information prediction model that is pre-trained, to predict volume adjustment information and obtain target volume adjustment information.

S330: determining a target volume corresponding to the target audio according to the target volume adjustment information and the reference volume.

S340: performing volume adjustment on the target audio based on the target volume, to enable an adjusted target audio to be played at the target volume.

In the technical solution of embodiments of the present disclosure, by analyzing the historical volume adjustment behavior information of the target user group for the target audio, a reference volume that is more suitable for the target user group and the target audio may be interred, and thus the accuracy of volume adjustment is improved.

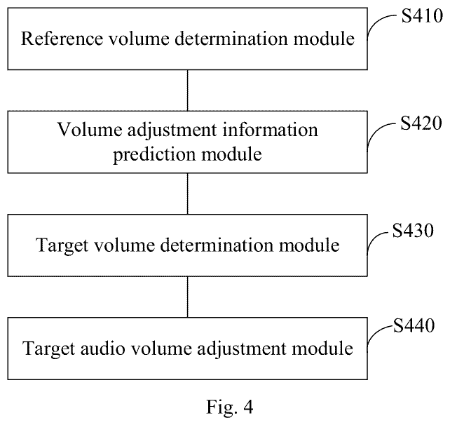

FIG. 4 is a schematic structural diagram of a volume adjustment apparatus in an embodiment of the present disclosure. As shown in FIG. 4, the apparatus specifically includes a reference volume determination module 410, a volume adjustment information prediction module 420, a target volume determination module 430 and a target audio volume adjustment module 440.

Here, the reference volume determination module 410 is configured to determine a reference volume corresponding to a target audio to be played. The volume adjustment information prediction module 420 is configured to input target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information. The target volume determination module 430 is configured to determine a target volume corresponding to the target audio according to the target volume adjustment information and the reference volume. The target audio volume adjustment module 440 is configured to perform volume adjustment on the target audio based on the target volume, to enable an adjusted target audio to be played at the target volume.

In the technical solution provided in the embodiments of the present disclosure, a reference volume corresponding to the target audio to be played is determined, and the target audio characteristic information corresponding to the target audio, the target user group characteristic information provided by the target user group, the current scenario characteristic information and the reference volume are input to the adjustment information prediction model that is pre-trained, to predict volume adjustment information and obtain target volume adjustment information; and according to the target volume adjustment information and the reference volume, a target volume that is more suitable for the target audio can be determined accurately, and the volume of the target audio is adjusted based on the target volume, so that the adjusted target audio can be played at a more suitable target volume automatically, thereby implementing dynamic adjustment of audio volume, eliminating the operation of adjusting the play volume manually by the user and thus improving the user experience.

On the basis of the above technical solution, the reference volume determination module 410 includes a first determination unit and a second determination unit.

The first determination unit is configured to predict play information of the target audio at a plurality of preset volumes based on the target audio characteristic information corresponding to the target audio to be played, the target user group characteristic information provided by the target user group and a plurality of play information prediction models that are pre-trained, and determine the reference volume corresponding to the target audio from the plurality of preset volumes based on a prediction result.

The second determination unit is configured to determine the reference volume corresponding to the target audio to be played based on historical volume adjustment behavior information of the target user group for the target audio to be played.

On the basis of the above technical solution, the first determination unit is specifically configured to input the target audio characteristic information corresponding to the target audio to be played and the target user group characteristic information provided by the target user group to each play information prediction model that is pre-trained, to predict play information of the target audio that has the preset volume for the target user group, where the play information prediction models are in one-to-one correspondence with the preset volumes; and determine the reference volume corresponding to the target audio from the plurality of preset volumes based on target play information output by each play information prediction model

On the basis of the above technical solution, the play information prediction models include first prediction models and second prediction models, the first prediction models are in one-to-one correspondence with first preset volumes, and the second prediction models are in one-to-one correspondence with second preset volumes.

The first determination unit is specifically configured to input the target audio characteristic information corresponding to the target audio to be played to each first prediction model that is pre-trained, to predict play information of the target audio that has the first preset volume, and determine a first reference volume corresponding to the target audio from a plurality of the first preset volumes based on first play information output by each first prediction model; input the target user group characteristic information provided by the target user group to each second prediction model that is pre-trained, to predict play information of the target audio that has the second preset volume for the target user group, and determine a second reference volume corresponding to the target user group from a plurality of the second preset volumes based on second play information output by each second prediction model; and determine the reference volume corresponding to the target audio based on the first reference volume and the second reference volume.

On the basis of the above technical solution, the second determination unit is specifically configured to determine a target variation relationship between historical play volumes and average play durations of the target audio based on the historical volume adjustment behavior information of the target user group for the target audio; and determine a target historical volume for which the average play duration of the target audio is longest, and determine the target historical volume as the reference volume corresponding to the target audio.

On the basis of the above technical solution, the target audio characteristic information includes target audio general characteristic information and/or target audio feedback characteristic information, the target audio feedback characteristic information includes historical volume adjustment behavior information of the target user group for the target audio and/or a target historical volume; and the current scenario characteristic information includes at least one selected from the group consisting of current play device characteristic information, current play environment characteristic information and current user behavior-pose information, the current play device characteristic information includes at least one selected from the group consisting of current position information of a volume adjustment bar of a play device, a current usage state of earphones and a loudspeaker, a current battery level and a current heating temperature.

On the basis of the above technical solution, the target audio is an audio in a target video to be played.

The volume adjustment information prediction module 420 is specifically configured to input the target audio characteristic information corresponding to the target audio, target video characteristic information, the target user group characteristic information provided by the target user group, the current scenario characteristic information and the reference volume to the adjustment information prediction model that is pre-trained, to predict the volume adjustment information and obtain the target volume adjustment information.

On the basis of the above technical solution, the target volume adjustment information includes a target volume adjustment behavior and a target volume adjustment magnitude, the target volume adjustment behavior includes a volume increasing behavior, a volume decreasing behavior or maintaining a volume unchanged.

The target volume determination module 430 is configured to: in response to the target volume adjustment behavior being the volume increasing behavior, increase the reference volume by the target volume adjustment magnitude to obtain the target volume corresponding to the target audio; in response to the target volume adjustment behavior being the volume decreasing behavior, decrease the reference volume by the target volume adjustment magnitude to obtain the target volume corresponding to the target audio; and in response to the target volume adjustment behavior being the maintaining a volume unchanged, determine the reference volume as the target volume corresponding to the target audio.

The volume adjustment apparatus provided in the embodiments of the present disclosure can perform the volume adjustment method provided in any embodiment of the present disclosure, and has a functional module and beneficial effect corresponding to the execution method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

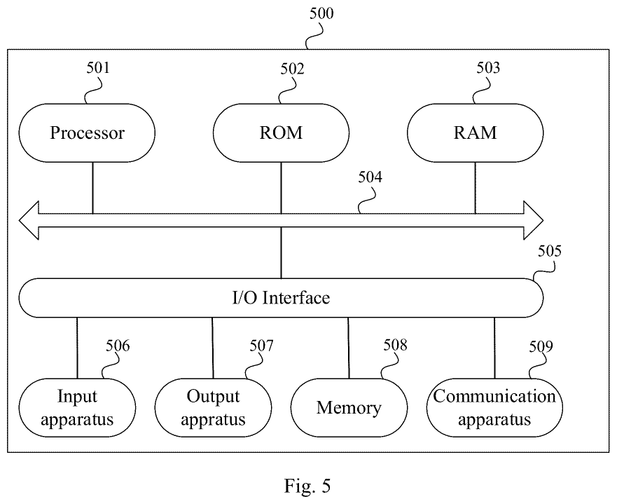

FIG. 5 is a schematic structural diagram of an electronic device in an embodiment of the present disclosure. Reference is made to FIG. 5 below, which is a structural schematic diagram of an electronic device 500 (such as a terminal device or a server in FIG. 5) suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processor (e.g., a central processing unit or a graphics processing unit) 501 that may perform a variety of appropriate actions and processing in accordance with a program stored in a read-only memory (ROM) 502 or a program loaded from a memory 508 into a random access memory (RAM) 503. The RAM 503 further stores various programs and data required for operations of the electronic device 500. The processor 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the memory 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the memory 508, or installed from the ROM 502. When the computer program is executed by the processor 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the volume adjustment method according to the above embodiments belong to the same inventive concept. For the technical details not described in detail in this embodiment, reference may made to the above embodiments, and this embodiment and the above embodiments have the same beneficial effects.

An embodiment of the present disclosure provides a computer storage medium storing a computer program thereon. When the program is executed by a processor, the processor implements the volume adjustment method according to the above embodiment.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determine a reference volume corresponding to a target audio to be played; input target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information; determine a target volume corresponding to the target audio according to the target volume adjustment information and the reference volume; and perform volume adjustment on the target audio based on the target volume, to enable an adjusted target audio to be played at the target volume.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases. For example, a programming interface display module may alternatively be described as “a module for obtaining a first programming element and a second programming element”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A volume adjustment method, comprising:
determining a reference volume corresponding to a target audio to be played;
inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information;
determining a target volume corresponding to the target audio according to the target volume adjustment information and the reference volume; and
performing volume adjustment on the target audio based on the target volume, to enable an adjusted target audio to be played at the target volume.

2. The volume adjustment method of claim 1, wherein the determining reference volume corresponding to a target audio to be played, comprises:
predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result; or
determining the reference volume corresponding to the target audio to be played based on historical volume adjustment behavior information of the target user group for the target audio to be played.

3. The volume adjustment method of claim 2, wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played and the target user group characteristic information provided by the target user group to each play information prediction model that is pre-trained, to predict play information of the target audio that has the preset volume for the target user group, wherein the play information prediction models are in one-to-one correspondence with the preset volumes; and
determining the reference volume corresponding to the target audio from the plurality of preset volumes based on target play information output by each play information prediction model.

4. The volume adjustment method of claim 2, wherein the play information prediction models comprise first prediction models and second prediction models, the first prediction models are in one-to-one correspondence with first preset volumes, and the second prediction models are in one-to-one correspondence with second preset volumes; and
wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played to each first prediction model that is pre-trained, to predict play information of the target audio that has the first preset volume, and determining a first reference volume corresponding to the target audio from a plurality of the first preset volumes based on first play information output by each first prediction model;
inputting the target user group characteristic information provided by the target user group to each second prediction model that is pre-trained, to predict play information of the target audio that has the second preset volume for the target user group, and determining a second reference volume corresponding to the target user group from a plurality of the second preset volumes based on second play information output by each second prediction model; and
determining the reference volume corresponding to the target audio based on the first reference volume and the second reference volume.

5. The volume adjustment method of claim 2, wherein the determining the reference volume corresponding to the target audio to be played based on historical volume adjustment behavior information of the target user group for the target audio to be played, comprises:
determining a target variation relationship between historical play volumes and average play durations of the target audio based on the historical volume adjustment behavior information of the target user group for the target audio; and
determining a target historical volume for which the average play duration of the target audio is longest, and determining the target historical volume as the reference volume corresponding to the target audio.

6. The volume adjustment method of claim 1, wherein the target audio characteristic information comprises target audio general characteristic information and/or target audio feedback characteristic information, the target audio feedback characteristic information comprises historical volume adjustment behavior information of the target user group for the target audio and/or a target historical volume; and
the current scenario characteristic information comprises at least one selected from the group consisting of current play device characteristic information, current play environment characteristic information and current user behavior-pose information, and the current play device characteristic information comprises at least one selected from the group consisting of current position information of a volume adjustment bar of a play device, a current usage state of earphones and a loudspeaker, a current battery level and a current heating temperature.

7. The volume adjustment method of claim 6, wherein the target audio is an audio in a target video to be played; and
the inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information, comprises:
inputting the target audio characteristic information corresponding to the target audio, target video characteristic information, the target user group characteristic information provided by the target user group, the current scenario characteristic information and the reference volume to the adjustment information prediction model that is pre-trained, to predict the volume adjustment information and obtain the target volume adjustment information.

8. The volume adjustment method of claim 1, wherein the target volume adjustment information comprises a target volume adjustment behavior and a target volume adjustment magnitude, the target volume adjustment behavior comprises a volume increasing behavior, a volume decreasing behavior or maintaining a volume unchanged; and
the determining a target volume corresponding to the target audio according to the target volume adjustment information and the reference volume, comprises:
in response to the target volume adjustment behavior being the volume increasing behavior, increasing the reference volume by the target volume adjustment magnitude to obtain the target volume corresponding to the target audio;
in response to the target volume adjustment behavior being the volume decreasing behavior, decreasing the reference volume by the target volume adjustment magnitude to obtain the target volume corresponding to the target audio; and
in response to the target volume adjustment behavior being the maintaining a volume unchanged, determining the reference volume as the target volume corresponding to the target audio.

9. An electronic device, comprising:
one or more processors; and
a memory, configured to store one or more programs,
wherein when the one or more programs are executed by the one or more processors, the one or more processors are caused to implement a volume adjustment method, and the volume adjustment method comprises:
determining a reference volume corresponding to a target audio to be played;
inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information;
determining a target volume corresponding to the target audio according to the target volume adjustment information and the reference volume; and
performing volume adjustment on the target audio based on the target volume, to enable an adjusted target audio to be played at the target volume.

10. A non-transitory storage medium, including computer-executable instructions, wherein when the computer-executable instructions are executed by a computer processor, the computer-executable instructions are used to perform a volume adjustment method, and the volume adjustment method comprises:
determining a reference volume corresponding to a target audio to be played;
inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information;
determining a target volume corresponding to the target audio according to the target volume adjustment information and the reference volume; and
performing volume adjustment on the target audio based on the target volume, to enable an adjusted target audio to be played at the target volume.

11. The electronic device of claim 9, wherein the determining reference volume corresponding to a target audio to be played, comprises:
predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result; or
determining the reference volume corresponding to the target audio to be played based on historical volume adjustment behavior information of the target user group for the target audio to be played.

12. The electronic device of claim 11, wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played and the target user group characteristic information provided by the target user group to each play information prediction model that is pre-trained, to predict play information of the target audio that has the preset volume for the target user group, wherein the play information prediction models are in one-to-one correspondence with the preset volumes; and
determining the reference volume corresponding to the target audio from the plurality of preset volumes based on target play information output by each play information prediction model.

13. The electronic device of claim 11, wherein the play information prediction models comprise first prediction models and second prediction models, the first prediction models are in one-to-one correspondence with first preset volumes, and the second prediction models are in one-to-one correspondence with second preset volumes; and
wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played to each first prediction model that is pre-trained, to predict play information of the target audio that has the first preset volume, and determining a first reference volume corresponding to the target audio from a plurality of the first preset volumes based on first play information output by each first prediction model;
inputting the target user group characteristic information provided by the target user group to each second prediction model that is pre-trained, to predict play information of the target audio that has the second preset volume for the target user group, and determining a second reference volume corresponding to the target user group from a plurality of the second preset volumes based on second play information output by each second prediction model; and
determining the reference volume corresponding to the target audio based on the first reference volume and the second reference volume.

14. The electronic device of claim 11, wherein the determining the reference volume corresponding to the target audio to be played based on historical volume adjustment behavior information of the target user group for the target audio to be played, comprises:
determining a target variation relationship between historical play volumes and average play durations of the target audio based on the historical volume adjustment behavior information of the target user group for the target audio; and
determining a target historical volume for which the average play duration of the target audio is longest, and determining the target historical volume as the reference volume corresponding to the target audio.

15. The electronic device of claim 9, wherein the target audio characteristic information comprises target audio general characteristic information and/or target audio feedback characteristic information, the target audio feedback characteristic information comprises historical volume adjustment behavior information of the target user group for the target audio and/or a target historical volume; and
the current scenario characteristic information comprises at least one selected from the group consisting of current play device characteristic information, current play environment characteristic information and current user behavior-pose information, and the current play device characteristic information comprises at least one selected from the group consisting of current position information of a volume adjustment bar of a play device, a current usage state of earphones and a loudspeaker, a current battery level and a current heating temperature.

16. The electronic device of claim 15, wherein the target audio is an audio in a target video to be played; and
the inputting target audio characteristic information corresponding to the target audio, target user group characteristic information provided by a target user group, current scenario characteristic information and the reference volume to an adjustment information prediction model that is pre-trained, to predict volume adjustment information and obtain target volume adjustment information, comprises:
inputting the target audio characteristic information corresponding to the target audio, target video characteristic information, the target user group characteristic information provided by the target user group, the current scenario characteristic information and the reference volume to the adjustment information prediction model that is pre-trained, to predict the volume adjustment information and obtain the target volume adjustment information.

17. The electronic device of claim 9, wherein the target volume adjustment information comprises a target volume adjustment behavior and a target volume adjustment magnitude, the target volume adjustment behavior comprises a volume increasing behavior, a volume decreasing behavior or maintaining a volume unchanged; and
the determining a target volume corresponding to the target audio according to the target volume adjustment information and the reference volume, comprises:
in response to the target volume adjustment behavior being the volume increasing behavior, increasing the reference volume by the target volume adjustment magnitude to obtain the target volume corresponding to the target audio;
in response to the target volume adjustment behavior being the volume decreasing behavior, decreasing the reference volume by the target volume adjustment magnitude to obtain the target volume corresponding to the target audio; and in response to the target volume adjustment behavior being the maintaining a volume unchanged, determining the reference volume as the target volume corresponding to the target audio.

18. The non-transitory storage medium of claim 10, wherein the determining reference volume corresponding to a target audio to be played, comprises:
predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result; or
determining the reference volume corresponding to the target audio to be played based on historical volume adjustment behavior information of the target user group for the target audio to be played.

19. The non-transitory storage medium of claim 18, wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played and the target user group characteristic information provided by the target user group to each play information prediction model that is pre-trained, to predict play information of the target audio that has the preset volume for the target user group, wherein the play information prediction models are in one-to-one correspondence with the preset volumes; and
determining the reference volume corresponding to the target audio from the plurality of preset volumes based on target play information output by each play information prediction model.

20. The non-transitory storage medium of claim 18, wherein the play information prediction models comprise first prediction models and second prediction models, the first prediction models are in one-to-one correspondence with first preset volumes, and the second prediction models are in one-to-one correspondence with second preset volumes; and
wherein the predicting play information of the target audio at a plurality of preset volumes based on the target audio characteristic information corresponding to the target audio to be played, the target user group characteristic information provided by the target user group and a plurality of play information prediction models that are pre-trained, and determining the reference volume corresponding to the target audio from the plurality of preset volumes based on a prediction result, comprises:
inputting the target audio characteristic information corresponding to the target audio to be played to each first prediction model that is pre-trained, to predict play information of the target audio that has the first preset volume, and determining a first reference volume corresponding to the target audio from a plurality of the first preset volumes based on first play information output by each first prediction model;
inputting the target user group characteristic information provided by the target user group to each second prediction model that is pre-trained, to predict play information of the target audio that has the second preset volume for the target user group, and determining a second reference volume corresponding to the target user group from a plurality of the second preset volumes based on second play information output by each second prediction model; and
determining the reference volume corresponding to the target audio based on the first reference volume and the second reference volume.
